(19) United States
(12) Patent Application Publication
(10) Pub. No.: US 2019/0034856 A1
(43) Pub. Date: Jan. 31, 2019

(54) SYSTEMS AND METHODS TO ENABLE DELIVERY OF COMMERCIAL PRODUCTS VIA AUTONOMOUS VEHICLES

(71) Applicant: Walmart Apollo, LLC, Bentonville, AR (US)

(72) Inventors: Donald R. High, Noel, MO (US); Todd D. Mattingly, Bentonville, AR (US); David C. Winkle, Bella Vista, AR (US); Michael D. Atchley, Springdale, AR (US); Brian G. McHale, Chadderton Oldham (GB); Nicholas R. Antel, Springdale, AR (US); John J. O'Brien, Farmington, AR (US)

(21) Appl. No.: 16/045,102

(22) Filed: Jul. 25, 2018

Related U.S. Application Data
(60) Provisional application No. 62/536,779, filed on Jul. 25, 2017.

(51) Int. Cl. G06Q 10/08

(52) U.S. Cl. CPC G06Q 10/083

(57) ABSTRACT

In some embodiments, apparatuses and methods are provided herein useful to enable delivery of commercial products via one or more modular autonomous vehicles. In some embodiments, the system may include databases and primary autonomous vehicles (PAVs). Each database can include information corresponding to commercial missions each defining delivery characteristic and commercial product characteristics of products scheduled for delivery to a delivery destination. Each PAV can include transceivers, storage areas (e.g., to store secondary autonomous vehicles (SAV), SAV components, and commercial objects), and control circuits. The control circuit(s) can be configured to assess commercial missions and select SAV components in accordance with assessed commercial missions. The control circuits can be configured to cause the selected SAV components to be affixed on the SAV.

### CROSS-REFERENCE TO RELATED APPLICATION

This application claims the benefit of the following U.S. Provisional Application No. 62/536,779 filed Jul. 25, 2017, which is incorporated herein by reference in its entirety.

### TECHNICAL FIELD

This invention relates generally to delivery of commercial products.

### BACKGROUND

Last mile delivery typically refers to the movement of commercial products from transportation hubs (e.g., a warehouse, a distribution center, and/or similar locations) to final delivery destinations (e.g., commercial and residential delivery destinations). A focus of last mile logistics is to deliver commercial products to delivery destinations in the least amount of time. Such decreases in delivery time can potentially aid merchants and/or commercial entities in providing psychologically beneficial shopping experiences to their customers.

### BRIEF DESCRIPTION OF THE DRAWINGS

Disclosed herein are embodiments of systems and methods pertaining to commercial product deliveries. This description includes drawings, wherein:

FIG. 1 comprises a block diagram as configured in accordance with various embodiments of these teachings.

FIG. 2 comprises a flow diagram as configured in accordance with various embodiments of these teachings.

FIG. 3 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems and methods are provided herein useful to enable delivery of commercial products via a plurality of autonomous vehicles.

The system may include one or more databases and primary autonomous vehicles (PAVs). Each database can include information corresponding to at least one commercial mission each defining a delivery characteristic(s) and a commercial product characteristic(s) of a commercial product(s) scheduled for delivery to a delivery destination. Each PAV can include one or more transceivers, storage areas, and control circuits. Each transceiver can be configured to enable communication with one or more secondary autonomous vehicles (SAV), where each SAV can include at least one SAV storage areas configured to temporarily receive at least one commercial product to facilitate the delivery.

Each storage area can be configured to store one or more of the SAV(s), the commercial product(s), as well as a plurality of SAV storage area functional components, SAV propulsion components each configured to facilitate longitudinal movement of the SAVs, and SAV auxiliary components. The control circuit(s) can be configured to assess each commercial mission. One or more of the SAV storage area functional components included in the plurality of SAV storage area functional components, SAV propulsion components included in the plurality of SAV propulsion components, and SAV auxiliary components included in the plurality of SAV auxiliary components that can enable the delivery to the delivery destination in accordance with the assessed commercial mission can be selected.

At least one of the selected SAV storage area functional components, SAV propulsion components, and SAV auxiliary components can be caused to be affixed onto the SAV. In some embodiments, the control circuit(s) can be configured to assess one of the commercial missions by ascertaining that the commercial product characteristic(s) dictates at least one sterility condition for which one or more of the commercial products is to be maintained. The control circuit(s) can be configured to cause the selection of one or more SAV storage area functional components included in the plurality of SAV storage area functional components that comprise a sterility component(s) that can maintain a sterility condition of each of the commercial products during the delivery.

In various embodiments of these teachings, methods are provided to enable delivery of commercial products via one or more autonomous vehicles. The method can include assessing one or more commercial missions each defining one or more commercial product characteristics and delivery characteristics. The method may include selecting one or more secondary SAV storage area functional components, SAV propulsion components, and SAV auxiliary components that can enable delivery of a commercial product(s) to a delivery destination(s) in accordance with at least one of the assessed commercial missions. Each of the commercial product(s) can be characterized by one or more of the commercial product characteristics and each of the deliveries can be characterized by the delivery characteristic(s). causing, via the control circuit, At least one of the selected SAV storage area functional components, the selected SAV propulsion components, and the selected SAV auxiliary components can be caused to be affixed onto (or within) a SAV included in the (storage area) PAV.

So configured, commercial mission data can be leveraged to select SAV components that facilitate delivery of commercial products. By one approach, such components can be used to temporarily configure a SAV in a manner that facilitates delivery of commercial products. Last mile delivery typically refers to the movement of commercial products from transportation hubs (e.g., a warehouse, a distribution center, and/or similar locations) to final delivery destinations (e.g., commercial and/or residential destinations). A focus of last mile logistics can be to deliver products to delivery destinations using the least amount of time. Such decreases in delivery time can potentially aid merchants and/or commercial entities in providing psychologically beneficial shopping experiences to their customers.

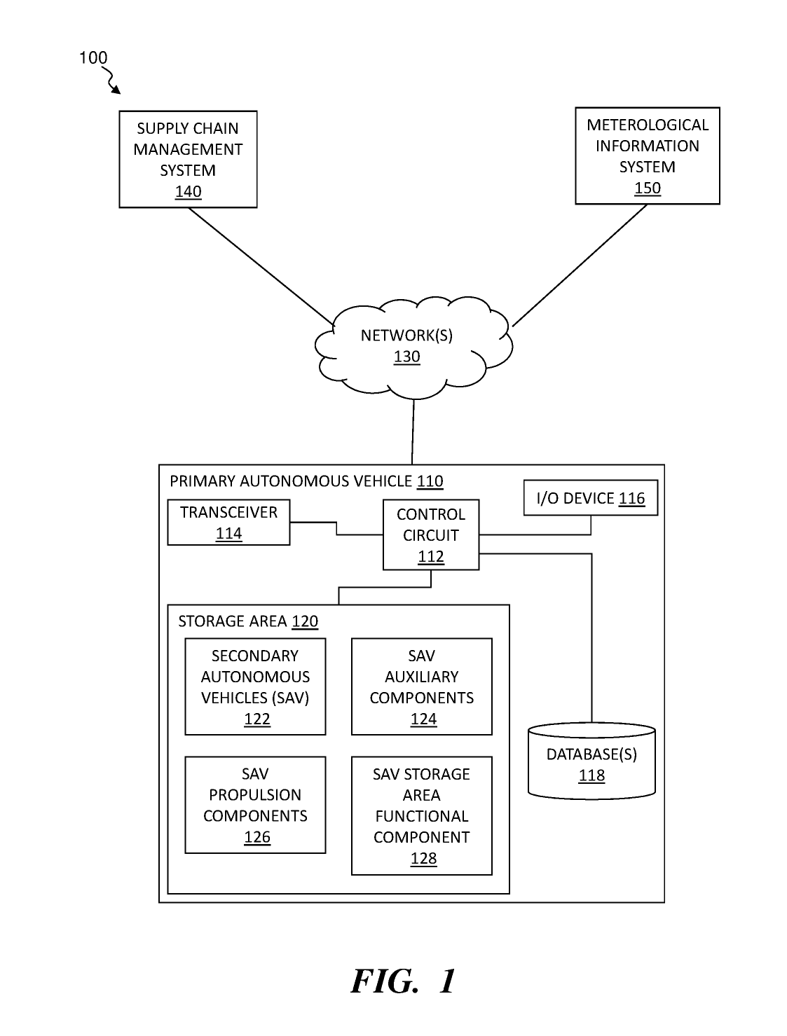

FIG. 1 illustrates a simplified block diagram of a system 100 to enable delivery of commercial products via autonomous delivery vehicles, in accordance with various embodiments of these teachings. System 100 can include one or more supply chain management systems (SCMS) 140, meteorological information systems (MIS) 150, and primary autonomous vehicles (PAV) 110 configured to communicate over a computer and/or one or more communications networks (“networks”) 130. Network 130 can be, for example, a local area network (LAN), a wide area network (WAN) such as the Internet, or a combination of the two, and includes wired, wireless, or fiber optic connections. In general, network 130 can be any combination of connections and protocols that can support communications between the SCMS 140, the MIS 150, and the PAV 110, in accordance with some embodiments of these teachings.

The MIS(s) 150 and the SCMS(s) 140 can each be one or more desktop computers, laptop computers, thin clients, servers, cluster computers, smart TVs, in-vehicle computing devices, wearable computing devices, mobile devices (e.g., smart phones, phablets, tablets, and similar devices) and/or similar devices, among others. The MIS(s) 150 and the SCMS(s) 140 can each include one or more input/output devices that facilitate user interaction with the device (e.g., displays, speakers, microphones, keyboards, mice, touch screens, joysticks, dongles, pointing devices, game pads, cameras, gesture-based input devices, and/or similar I/O devices).

Weather can play a significant role in various aspects of logistics (e.g., shipping and delivery route planning). Meteorological data can be leveraged for planning and/or implementing last mile delivery events. For example, deliveries of perishable commercial products (e.g., food items that can spoil, decay, or become unsafe to consume if not kept refrigerated at 40 F.° or below or frozen at 0 F.° or below), may benefit from transportation within storage areas capable of maintaining climatic conditions regardless of the ambient meteorological conditions. In various embodiments of these teachings, the MIS 150 can be a system configured to capture, store, analyze, and/or transmit meteorological data (e.g., to SCMS 140, SAV 122, and/or PAV 110).

In some embodiments, MIS 150 can include one or more sensors (e.g., thermometers, barometers, anemometers, hygrometers, ceilometers, falling precipitation sensors, flood sensors, lightning sensors, microphones (e.g., to detect explosions, sonic booms, and/or thunder), pyranometers, pyrheliometers, spectroradiometers, rain gauges, snow gauges, scintillation counters (e.g., to detect background radiation, fallout, and/or radon), seismometers, transmissometers, and GPS clocks for data logging, similar sensors, or a combination of two or more thereof) that are configured to capture meteorological data (e.g., heat, humidity, barometric pressure, wind speed and direction, snow accumulation, rain accumulation, similar meteorological data, or a combination of two or more thereof). In some embodiments, MIS 150 can be configured to transmit historic and/or real-time meteorological data to one or more of the SCMSs 140, PAVs 110, SAVs 122, and central control circuit(s) for storage therein. For example, “real-time” meteorological data can correspond to meteorological data that is transmitted within milliseconds of being captured (or other time period that users sense as being sufficiently immediate or that enables the MIS 150 to keep up with one or more processes, steps, functions of these teachings).

In various embodiments of these teachings, the SCMS 140 can be a system configured to receive and/or process orders for one or more commercial entities. Such orders may be generated by one or more other commercial entities and/or consumers. By one approach, orders can include information that dictates the delivery of commercial products to recipients (e.g., delivery destinations, recipients, dates/times, commercial product information, etc.). SCMS 140 can receive and/or remotely access commercial product information (e.g., descriptions, storage conditions, dimensions, and/or similar product information) specified in one or more orders. In some embodiments, DMS 140, SAV 122, and/or PAV(s) 110 can be configured to use orders to generate commercial missions. For example, commercial missions can include information corresponding to delivery characteristics and commercial products characteristics that can be can be utilized by the SAVs 122 to facilitate delivery of commercial products to delivery destinations (discussed below). For example, each commercial mission can correspond to one or more orders. By one approach, orders for particular geographic areas (e.g., regions, addresses, streets, cities, etc.) can be aggregated in one or more commercial missions, while in other instances, individual orders or parts of an individual orders may be aggregated in one or more commercial missions.

In various embodiments, the PAV(s) 110 can include autonomous, semi-autonomous, and/or manned mobile machines that can be configured to store and transport SAV(s) 122 as well as commercial products to be delivered by the SAV(s) 122. In some embodiments of these teachings, the PAV 110 is, for example, a mobile warehouse, distribution center, and/or similar commercial structure that can be configured to store goods to be redistributed to retailers, wholesalers, and/or consumers. The PAV(s) 110, for example, can be configured to traverse environments via the use of one or more terrestrial propulsion systems, aerial propulsion systems, aquatic propulsion systems, similar propulsion systems, or a combination of two or more thereof. For example, PAV 110 can include one or more databases 118, I/O devices 116, transceivers 114, and storage areas 120 communicatively coupled to one or more control circuits 112, in accordance with some embodiments of these teachings. In this description, it will be presumed that the control circuit(s) 112 can be configured to carry out one or more of the described activities, steps, and/or processes of these teachings.

Being a “circuit,” this control circuit 112 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings. Such a control circuit 112 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here.

In some embodiments, the database(s) 118 can include information corresponding to one or more of meteorological data, orders, commercial missions, navigational mapping information (e.g., road maps, aeronautical charts, nautical charts, railroad network maps, hiking maps, bicycling maps, similar mapping information, or a combination of two or more thereof for one or more particular regions), similar information, or a combination of two or more thereof. In some embodiments, mapping information can include a plurality of waypoints (i.e., physical spaces corresponding to longitudinal and longitudinal coordinates) and edges, where each edge connects two waypoints. Each edge can have a value that represents a road distance between a particular waypoint pair. As such, edges may or may not represent unique values. Each waypoint can represent a point at which the course of the road can change (e.g., intersections, access points, junctions, on-ramps, off-ramps, similar locations where multiple roads intersect, allowing vehicular traffic to change from one road to another).

In various embodiments, a delivery route can correspond to a sequence of edges that are linked to each other at waypoints and form a path to traverse to reach a delivery destination or final point from a point of origin or starting point. In many cases, more than one path links an origin to a destination. In some embodiments, delivery routes to delivery destinations can be generated (e.g., by SCMS 140, PAV 110, SAV 122, central control circuits, or a combination of two or more thereof) using any method known in the art. Some or all of the information included in the database(s) 118 can be information received from the MIS(s) 150, the SCMS(s) 140, other PAVs 110, other SAVs 122, central control circuits, or a combination of two or more thereof. By one approach, the I/O device(s) 116 can be input/output devices configured to facilitate user interaction with the PAV 110 (e.g., displays, speakers, microphones, keyboards, mice, touch screens, joysticks, dongles, pointing devices, game pads, cameras, gesture-based input devices, and similar I/O devices). For example, the I/O device(s) 116 can be utilized to enter information into the database(s) 118 (e.g., meteorological data, orders, commercial missions, navigational mapping information, similar information, or a combination of two or more thereof).

The transceiver 114 can be a device(s) configured to facilitate wireless (i.e., radio frequency) communication with one or more of the MIS(s) 150, SCMS(s) 140, the network(s) 130, the SAV(s) 122, central control circuits, other computing devices, or a combination of two or more thereof. For example, transceiver 114 can be configured to transmit at least a portion of the data included in database 118 to one or more SAVs 122 as well as other PAVs 110. By one approach, the PAV 110 can be configured to include one or more storage areas 120. In some embodiments, each storage area 120 can include one or more SAV(s) 122, SAV propulsion components 126, SAV auxiliary components 124, SAV storage area functional components 128, other components to be utilized with an SAV, products for delivery, or a combination of two or more thereof. By one approach, last mile delivery events may include a variety of delivery destinations, commercial product dimensions, and commercial products storage conditions, which may frustrate the use of a single type of commercial delivery vehicle for deliveries. For example, the fuel economy of SAV(s) 122 can be improved when the SAV(s) 122 are equipped with non-extraneous components, which can minimize the overall weight thereof and/or increase/maximize storage capacity. As such, various embodiments of these teachings provide modular SAVs that can be equipped by the PAV 110 in a variety of configurations to facilitate delivery of a variety of commercial products to a variety of delivery destinations. As discussed above, the PAVs 110 can be, for example, mobile warehouses, distribution centers, and/or similar commercial structures that can be configured to store goods to be redistributed to retailers, wholesalers, and/or consumers. As such, the use of PAVs 100 can provide many benefits (e.g., negate/reduce the need to employ permanent storage structures, reduce commercial product storage costs associated with permanent storage structures, provide warehousing capabilities to areas associated with non-cost effective warehousing costs, similar benefits, or a combination of two or more thereof). For example, the operational costs associated the PAVs 110 (e.g., energy, maintenance, etc.) can be reduced and/or eliminated when the PAV 100 is not in use.

In various embodiments, the PAVs 110 of these teachings can configure the SAV(s) 122 to facilitate delivery of commercial products in accordance with commercial missions. By one approach, the PAV 110 may be configured to temporarily incorporate within the frame of the SAVs 122 one or more of the SAV propulsion components 126, the SAV storage area functional components 128, and the SAV auxiliary components 124 to the SAVs 122 using one or more methods known in the art. For example, the PAV 110 may incorporate such components within the SAVs 122 using one or more magnets, screws, bolts, clasps, clamps, latches, pins, rivets, straps, grommets, retaining rings, similar fasteners and/or couplers, or a combination of two or more thereof. In various embodiments of these teachings, one or more of the SAV propulsion components 126, the SAV storage area functional components 128, and the SAV auxiliary components 124 incorporated within the frame of the SAV 122 can be conductively coupled to the one or more control circuits of the SAV 122.

The SAV(s) 122 can be modular autonomous and/or semi-autonomous vehicles that can be configured to deliver commercial products to delivery destinations in accordance with commercial missions. Each of the SAVs 122 can have one or more SAV storage area temporarily or permanently secured to the frame of the SAV 122 and configured to store commercial products. SAV storage areas can each have a universal volume or different volumes. In some embodiments, two or more SAVs 122 can be configured to traverse an environment in a convoy configuration where two or more SAVs 122 can coordinate their longitudinal movement. The SAV 122 can include a database to store orders and/or commercial missions (e.g., stored in a lookup table).

One or more of the PAVs 110 and SAVs 122 can be powered by gasoline, electricity, hydrogen, solar energy, similar energy sources, or a combination of two or more thereof. By one approach, propulsion systems of these teachings can include one or more energy sources, engines (e.g., electric engines and internal combustion engines), and actuators.

In some embodiments, SAV propulsion components 126 can include, but are not limited to, one or more terrestrial propulsion systems (e.g., propulsion systems that employ tracks, wheels, sleds, skis, ice skates, and/or similar structures that can facilitate terrestrial movement), aerial propulsion systems (e.g., propulsion systems that employ rotors, jet engines, propellers, propulsive nozzle, and/or similar components that can generate thrust sufficient to facilitate aerial movement), aquatic propulsion systems (e.g., propulsion systems that employ one or more propellers, pump-jets, impellers, sails, paddle wheels, screws, and/or similar components that can generate thrust sufficient to facilitate movement across/within a body of water), similar propulsion systems, or a combination of two or more thereof.

As stated above, commercial missions can each define one or more delivery destinations. In some embodiments, delivery destinations may require the SAVs 122 to traverse one or more steps or elevated platforms to execute delivery of the commercial products. In some embodiments, the SAV auxiliary components 124 can include one or more wheeled and/or tracked stair climbing apparatuses, which are well known in the art and require no further discussion herein (e.g., the stair climbing apparatuses disclosed in U.S. Pat. No. 3,869,011 to Jensen, U.S. Pat. No. 4,033,595 to Mauch, and U.S. Pat. No. 4,993,912 to King et al. each of which are herein incorporated by reference) and/or similar stair/platform climbing mechanisms that can allow the SAVs 122 to traverse steps or elevated platforms.

Storage condition requirements can vary between commercial products. For example, some commercial products are perishable and therefore have an increased probability of spoilage, decay or becoming unsafe to consume if not kept refrigerated at/near 40 F.° (4.4° C.) or below or frozen at/near 0 F.° (−17.8° C.) or below. Similarly, some commercial products (e.g., foods, pharmaceuticals, chemicals, etc.) can have storage conditions that necessitate the exclusion of air, oxygen, or other gases (e.g., to reduce the effects of oxidation and/or similar deleterious reactions). In some embodiments, SAV storage area functional components 128 can include one or more devices that can be configured to control the climate (e.g., temperature, pressure, humidity, and/or similar climate conditions) of SAV storage areas as well as one or more devices that can exclude the passage of air, oxygen, and/or similar gases from SAV storage areas and thereby generate a hermetic seal therein. Some delivery destinations may require the SAVs 122 to traverse hinged/moveable barriers (e.g., gates, doors, and/or similar hinged/moveable structures) to deliver commercial goods. In some embodiments, SAV auxiliary components 124 can include one or more mechanized articulated appendages (which are well known in the art and require no additional discussion herein) having one or more joints that can be configured to manipulate doors, gates, garage doors, mail slots/boxes, and/or similar hinged/moveable structures, in accordance with various embodiments of these teachings.

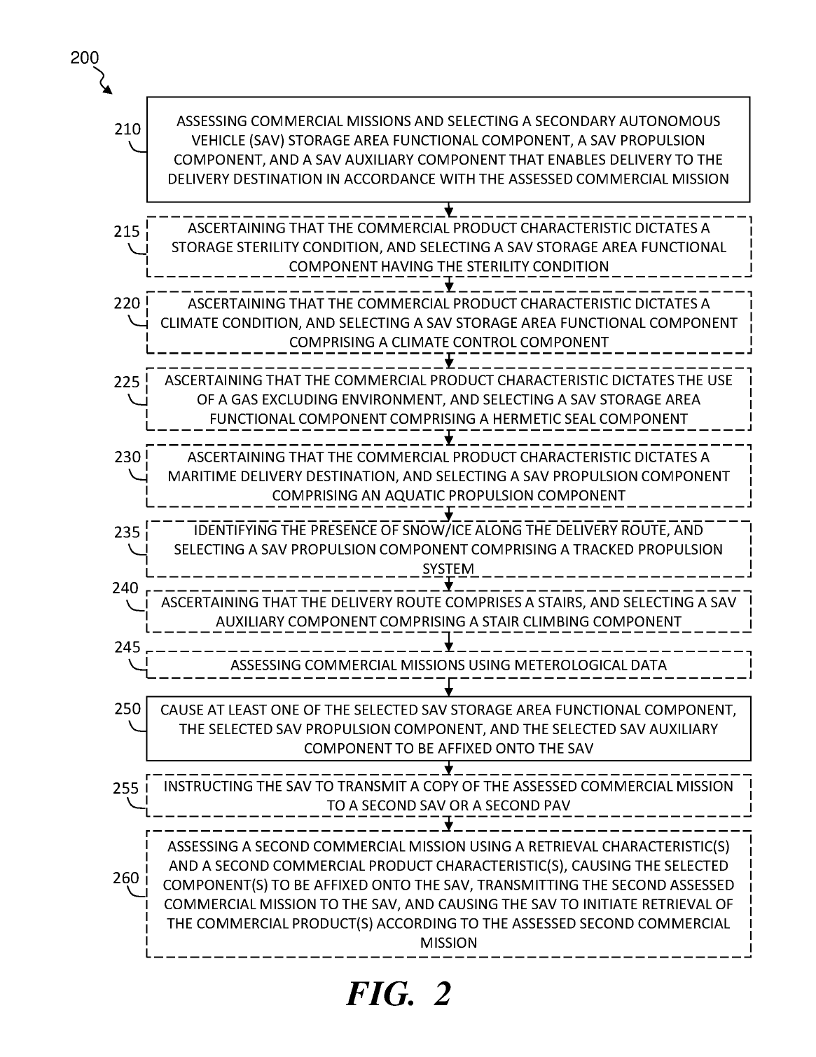

Referring now to FIG. 2. In particular, FIG. 2 illustrates simplified flow diagram of a process 200 with operational steps of enabling delivery of commercial products via one or more autonomous vehicles, in accordance with some embodiments of these teachings. At block 210, one or more commercial missions (e.g., of the database(s) 118, the SAV 122, the SCMS 140, the MIS 150, a central control circuit(s), network(s) 130, or a combination of two or more thereof) can be assessed (e.g., by reviewing the details of the one or more commercial missions and selecting the SAV components that facilitate the delivery of the commercial products prescribed by the commercial missions). By one approach, each commercial mission may define one or more commercial product characteristics and one or more delivery characteristics. As a result of assessing the commercial mission, one or more SAV storage area functional components, SAV propulsion components, and SAV auxiliary components can be selected that enable delivery of one or more commercial products defined in the commercial mission to at least one delivery destination. Commercial products of storage area 120 defined by the assessed commercial mission can be transferred to the storage area of the SAV 122 being configured consistent with the commercial mission and the corresponding commercial product characteristics and delivery characteristics. By one approach, each commercial product can be characterized by at least one of the commercial product characteristic (e.g., storage condition, weight, dimensions, etc.). By one approach, the delivery can be characterized by the delivery characteristic(s) (e.g., routing information, delivery destination, recipient information, the location/number of stairs/elevated platforms, the location/number of hinged barriers, etc.).

In some embodiments, commercial product characteristics and delivery characteristics for commercial missions can be stored in a lookup table or similar indexing array stored in one or more database(s) 118, database(s) associated with SCMS 140, MIS 150, network 130, central control circuit(s), or a combination of two or more thereof, which can reduce processing time. At block 215, one or more of the commercial missions can be assessed to ascertain when one or more of the commercial product characteristics dictate a sterility condition (i.e., a germ-free storage area) for which one or more of the commercial products is to be maintained during the delivery. By one approach, the PAV 110 can be caused to select at least one SAV storage area functional component 128 included in the plurality of SAV storage area functional components 128 of the storage area 120 that includes at least one sterility component that can maintain the sterility condition of the commercial product(s) during the delivery. For example, one or more SAV storage area functional components 128 can be selected that provide UV-lighting and/or chemical dispersions (e.g., bleach, isopropyl alcohol, and/or similar chemicals) that facilitate the maintenance of a sterile storage area 120.

At block 220, one or more of the commercial missions can be assessed to ascertain that the commercial product characteristic(s) dictates one or more climate conditions (e.g., temperature, pressure, humidity, similar climate conditions, or a combination of two or more thereof) at which one or more of the commercial products is to be maintained during the delivery. For example, the PAV 110 can be caused to select at least one SAV storage area functional component 128 included in the plurality of SAV storage area functional components 128 that includes at least one climate control component that can be activated to achieve and/or maintain the prescribed climate condition(s) during the delivery processes. At block 225, the commercial mission can be assessed to ascertain that the commercial product characteristic(s) dictates maintenance of at least one of the commercial products in a gas excluding environment. For example, the PAV 110 can be caused to select at least one SAV storage area functional component 128 of the plurality of SAV storage area functional components 128 that includes a hermetic seal component or other component that can facilitate the formation of a gas excluding environment.

At block 230, one or more of the commercial missions can be assessed to ascertain that the delivery characteristic(s) dictates at least one maritime delivery destination and/or a portion of the delivery route includes traversing water (e.g., such delivery destinations can be defined by latitude and longitude or similar coordinate systems). As discussed above, delivery routes can be can be generated by SCMS 140, PAV 110, SAV 122, central control circuits, or a combination of two or more thereof. The generated delivery route associated with the commercial mission can be compared to the mapping information of the database(s) 118 to determine whether the delivery destination and/or a portion of the delivery route includes traversing water. In some embodiments, this assessment can be executed by one or more central control circuits before the PAV/SAV are released in to service. Generated delivery routes Based on the determination that the delivery destination and/or a portion of the delivery route includes traversing water, the PAV 110 can be caused to select at least one SAV propulsion component 126 of the plurality of SAV propulsion components 126 that comprises an aquatic propulsion component. In some embodiments, when the delivery characteristic(s) dictates at least one maritime delivery destination and/or a portion of the delivery route includes traversing water an aerial propulsion system of the SAV propulsion components 126 can be selected when the combined weight of the commercial products stored in the SAV storage area do not exceed the lift capacity of the aerial propulsion system. However, meteorological conditions (e.g., snow, rain, wind speeds in excess of 32 MPH, etc.) can frustrate the use of aerial propulsion systems when such conditions increase the probability that the SAV will experience an impact event (i.e. a crash, accident, etc.) and/or mechanical failure. At block 335, one or more of the commercial missions can be assessed to identify the presence along one or more of the delivery routes of at least a threshold amount of at least one of snow and ice. By one approach, the PAV 110 can cause to select one or more SAV propulsion components 126 that includes, for example, a tracked propulsion system. For example, MIS 150, SCMS 140, database(s) 118, database(s) communicatively coupled to network(s) 130, or a combination thereof can be accessed to identify meteorological data associated with at least a portion of the delivery route(s).

Identified meteorological data can be assessed to determine whether a portion of at least one of the delivery routes has experienced (or will experience) a threshold amount of snow fall and/or ice accumulation. For example, the threshold amount can be determined on a case by case basis, by the user, the PAV 110, the SAV 122 (e.g., using sensors to detect the presence of snow and/or ice). In some embodiments of these teachings, the SAV 122 can be configured to convert to a tracked mechanism when the threshold amount of snow and/or ice is detected, when the longitudinal motion of the SAV 122 becomes frustrated by snow and/or ice, as well as similar conditions that impede the longitudinal motion of the SAV 122. By one approach, meteorological conditions (e.g., snow, rain, wind speeds in excess of 32 MPH, etc.) can frustrate the use of aerial propulsion systems when such conditions increase the probability that the SAV will experience an impact event (i.e. a crash, accident, etc.) and/or mechanical failure. When such conditions are present, the use of tracked and/or similar mechanisms that facilitate the traversal of snow/ice can be selected.

As previously stated, delivery routes can each correspond to a sequence of edges that are linked to each other at waypoints and form a path to traverse to reach a delivery destination or final point from a point of origin or starting point. In various embodiments, meteorological data associated with one or more portions of delivery routes (e.g., one or more edges and waypoints) can be assessed to identify the presence of a threshold amount of snow and/or, the presence of which can be used to select one or more SAV propulsion components 126 that can facilitate the traversal of the SAV 122 through the environment having the threshold amount of snow and/or ice.

At block 240, one or more of the commercial missions can be assessed to ascertain whether the delivery characteristic(s) dictates one or more delivery routes that include the presence of one or more stairs (or elevated platforms). By one approach, such information can be provided by consumers during completion of their purchase orders. Historic delivery data may be available that identifies based on previous delivery attempts that there are one or more sets of stairs and/or other obstructions. Similarly, one or more historic delivery date acquired from delivery personnel, third party services, or the like may be accessed in evaluating delivery conditions. When the commercial mission dictates the presence of one or more stairs (and/or elevated platforms), the PAV 110 can be caused to select one or more SAV auxiliary components 124 that include at least one stair climbing component. At block 245, one or more of the commercial missions can be assessed using meteorological data for one or more areas associated with the delivery.

For example, meteorological data can be assessed to identify the appropriate SAV propulsion component(s) 126 (as discussed above), modify/plan delivery routes (e.g., using any of the methods known in the art), adjust delivery timing, and the like. At block 250, at least one of the selected SAV storage area functional components 128, the selected SAV propulsion components 126, and the selected SAV auxiliary components 124 can be caused to be affixed onto (and/or within) one of the SAVs 122 by the PAV 110. For example, PAV 110 can include one or more apparatuses, devices, mechanisms (which are well known in the art and require no further discussion herein) that can be used to affix one or more SAV storage area functional components 128, SAV propulsion components 126, and/or SAV auxiliary components 124 onto or within the frame of SAVs 122 in accordance with assessed commercial missions.

At block 255, code (e.g., of database(s) 118, MIS 150, SCMS 140, central control circuits, and/or similar entities) can be transmitted to the SAV 122 that instructs the SAV 122 to transmit a copy of the assessed commercial mission(s) to one or more second SAVs 122 and second PAVs 110. For example, mechanical devices (e.g., SAVs 122 and PAVs 110) can experience mechanical failures during the course of their operational lifecycle. When SAVs 122 experience a mechanical failure while executing commercial missions, delivering the commercial products according to their assessed commercial missions can be frustrated (e.g., when commercial products are not delivered on time), which may reduce customer satisfaction. By one approach, SAVs 122 can transmit their commercial missions as well as transfer commercial products (e.g., using one or more articulated appendages or similar devices) stored in their storage areas to the storage areas of other SAVs 122 or PAV(s) 110 and thereby reduce the impact of mechanical failures on the execution of commercial missions.

In various embodiments of these teachings, the SAV(s) 122 can be configured to retrieve commercial products from pickup locations (e.g., to facilitate the return of purchased commercial items). At block 260, one or more second commercial missions (e.g., of the databases 118, the SCMSs 140, SAVs 122, central control circuits, etc.) can be assessed where each second commercial mission comprises information corresponding to one or more retrieval characteristics (e.g., retrieval routes, pickup locations, location and quantity of hinged barriers, and/or similar information) and second commercial product characteristics (e.g., commercial product identifying information, dimensions, weight values, storage conditions and/or similar product information). One or more SAV storage area functional components 128, SAV propulsion components 126, and SAV auxiliary components 124 that may each enable retrieval of a commercial product(s) from a retrieval source(s) can be selected in accordance with the assessed second commercial mission. For example, commercial products to be retrieved can be characterized by the second commercial product characteristics and the retrievals characterized by the retrieval characteristics.

In some embodiments, the PAV 110 can be caused to affix one or more of the selected SAV storage area functional components, the selected SAV propulsion components, and the selected SAV auxiliary components onto and/or within the frame of the SAV 122. For example, one or more of the assessed second commercial mission can be transmitted to the SAV 122 (e.g., by the PAV 110, a central control circuit(s), SCMS 140, or a combination of two or more thereof) included in the PAV 110. By one approach, the PAV 110, a central control circuit(s), SCMS 140, or a combination of two or more thereof can cause the SAV 122 to initiate retrieval of the commercial product from the retrieval source according to the assessed second commercial mission.

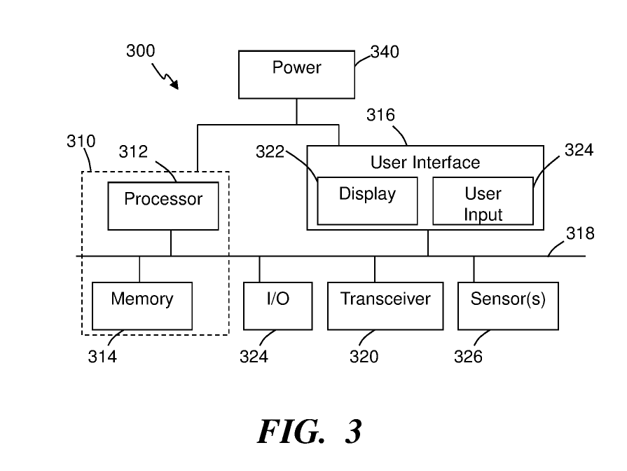

Further, the circuits, circuitry, systems, devices, processes, methods, techniques, functionality, services, servers, sources and the like described herein may be utilized, implemented and/or run on many different types of devices and/or systems. FIG. 3 illustrates an exemplary system 1000 that may be used for implementing any of the components, circuits, circuitry, systems, functionality, apparatuses, processes, or devices of the MIS 150, SCMS 140, PAV 110, SAV 122 and/or the control circuit 112 of the PAV 110 and/or other above or below mentioned systems or devices, or parts of such circuits, circuitry, functionality, systems, apparatuses, processes, or devices. For example, the system 300 may be used to implement some or all of the PAV 110, the control circuit 112, one or more other control circuits and/or processing systems of the SAV 122 (e.g., video processing systems, image processing systems, sensor data processing systems, emitter system, and the like), one or more remote central control systems, and/or other such components, circuitry, functionality and/or devices. However, the use of the system 300 or any portion thereof is certainly not required.

By way of example, the system 300 may comprise a control circuit or processor module 312, memory 314, and one or more communication links, paths, buses or the like 318. Some embodiments may include one or more user interfaces 316, and/or one or more internal and/or external power sources or supplies 340. The control circuit 312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 312 can be part of control circuitry and/or a control system 310, which may be implemented through one or more processors with access to one or more memory 314 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 300 may be used to implement one or more of the above or below, or parts of, components, circuits, systems, processes and the like.

The user interface 316 can allow a user to interact with the system 300 and receive information through the system. In some instances, the user interface 316 includes a display 322 and/or one or more user inputs 324, such as buttons, touch screen, track ball, keyboard, mouse, etc., which can be part of or wired or wirelessly coupled with the system 300. Typically, the system 300 further includes one or more communication interfaces, ports, transceivers 320 and the like allowing the system 300 to communicate over a communication bus, a distributed computer and/or communication network 130 (e.g., a local area network (LAN), the Internet, wide area network (WAN), etc.), communication link 318, other networks or communication channels with other devices and/or other such communications or combination of two or more of such communication methods. Further the transceiver 320 can be configured for wired, wireless, optical, fiber optical cable, satellite, or other such communication configurations or combinations of two or more of such communications. Some embodiments include one or more input/output (I/O) ports 334 that allow one or more devices to couple with the system 300. The I/O ports can be substantially any relevant port or combinations of ports, such as but not limited to USB, Ethernet, or other such ports. The I/O interface 334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 326 to provide information to the system and/or sensor information that is communicated to another component, such as the central control system, control circuits 112, MIS(s) 150, SCMS(s) 140, SAV(s) 122, etc. One or more sensors 326 can be implemented through one or more sensors 718. The sensors can include substantially any relevant sensor, such as distance measurement sensors (e.g., optical units, sound/ultrasound units, etc.), cameras, motion sensors, inertial sensors, climate sensors (e.g., temperature, humidity, pressure, etc.), accelerometers, impact sensors, pressure sensors, geopositional sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 300 comprises an example of a control and/or processor-based system with the control circuit 312. Again, the control circuit 312 can be implemented through one or more processors, controllers, central processing units, logic, software and the like. Further, in some implementations the control circuit 312 may provide multiprocessor functionality.

The memory 314, which can be accessed by the control circuit 312, typically includes one or more processor readable and/or computer readable media accessed by at least the control circuit 312, and can include volatile and/or nonvolatile media, such as RAM, ROM, EEPROM, flash memory and/or other memory technology. Further, the memory 314 is shown as internal to the control system 310; however, the memory 314 can be internal, external or a combination of internal and external memory. Similarly, some or all of the memory 314 can be internal, external or a combination of internal and external memory of the control circuit 312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 130. The memory 314 can store code, software, executables, scripts, data, content, lists, programming, programs, log or history data, blockchains, commercial agreements, product information, and the like. While FIG. 3 illustrates the various components being coupled together via a bus, it is understood that the various components may actually be coupled to the control circuit and/or one or more other components directly.

In some embodiments of these teachings, a systems are provided to enable delivery of commercial products via a plurality of autonomous vehicles. The system may include one or more databases and primary autonomous vehicles (PAVs). Each database can include information corresponding to at least one commercial mission each defining a delivery characteristic(s) and a commercial product characteristic(s) of a commercial product(s) scheduled for delivery to a delivery destination. Each PAV can include one or more transceivers, storage areas, and control circuits. Each transceiver can be configured to enable communication with one or more secondary autonomous vehicles (SAV), where each SAV can include at least one SAV storage areas configured to temporarily receive at least one commercial product to facilitate the delivery.

Each storage area can be configured to store the SAV(s), the commercial product(s), as well as a plurality of SAV storage area functional components, SAV propulsion components each configured to propel any of the SAVs, and SAV auxiliary components. The control circuit(s) can be configured to assess at least one of the commercial missions. One or more of the SAV storage area functional components included in the plurality of SAV storage area functional components, SAV propulsion components included in the plurality of SAV propulsion components, and SAV auxiliary components included in the plurality of SAV auxiliary components that can enable the delivery to the delivery destination in accordance with an assessed commercial mission can be selected.

At least one of the selected SAV storage area functional components, SAV propulsion components, and SAV auxiliary components can be caused to be affixed onto the SAV. In some embodiments, the control circuit(s) can be configured to assess one of the commercial missions by ascertaining that the commercial product characteristic(s) dictates at least one sterility condition for which one or more of the commercial products is to be maintained. The control circuit(s) can be configured to cause the selection of one or more SAV storage area functional components included in the plurality of SAV storage area functional components that comprise a sterility component(s) that can maintain a sterility condition of each of the commercial products during the delivery.

In some embodiments, the control circuit(s) can be configured to assess one or more of the commercial mission by selecting one or more SAV storage area functional components of the plurality of SAV storage area functional components that include at least one climate control component when the commercial product characteristic(s) dictates one or more climate conditions for which one or more of the commercial products is to be maintained for the delivery. By one approach, the control circuit(s) can be configured to assess one of the commercial missions by selecting one or more SAV storage area functional components of the plurality of SAV storage area functional components that include at least one hermetic seal components when one or more of the commercial product characteristics dictate maintenance of at least one of the commercial products in a gas excluding environment.

In some embodiments, the control circuit(s) can be configured to assess one or more of the commercial missions by selecting one or more SAV propulsion components of the plurality of SAV propulsion components that include an aquatic propulsion component(s) when the delivery characteristic dictates a maritime delivery destination. By one approach, the control circuit(s) can be configured to assess one or more of the commercial missions by identifying the presence along a delivery route of at least a threshold amount of one or more of snow and ice, and direct the selection of one or more SAV propulsion components that include a tracked propulsion system(s). In various embodiments, the control circuit(s) can be configured to assess one or more of the commercial missions by selecting at least one SAV auxiliary component of the plurality of SAV auxiliary components that includes a stair climbing component when one or more of the delivery characteristics dictate a delivery route(s) that have a threshold number of stairs.

The control circuit(s) can be configured to assess one or more of the commercial missions using the delivery characteristic(s), the commercial product characteristic(s), and weather data for one or more areas associated with the delivery. In some embodiments, the SAV can include one or more second transceivers and second control circuits communicatively coupled to the second transceiver(s), where the second control circuit(s) can be configured to cause the second transceiver(s) to transmit at least one copy of the assessed commercial mission to one or more second PAVs and second SAVs. For example, each copy of the assessed commercial mission may be received, via the second transceiver, from the PAV.

In various embodiments of these teachings, one or more of the databases may further include information corresponding to one or more second commercial missions each defining retrieval characteristic(s) associated with commercial product(s) scheduled for retrieval from retrieval source(s). Each second commercial mission may further define second commercial product characteristic(s) associated with the commercial product(s) scheduled for retrieval. Each of the second commercial missions can include code that instructs the SAV to execute the retrieval from the retrieval source. The control circuit(s) may be further configured to assess the second commercial mission using at least the retrieval characteristic(s) and the second commercial product characteristic(s). One or more second SAV storage area functional components of the plurality of SAV storage area functional components, second SAV propulsion components included in the plurality of SAV propulsion components, and second SAV auxiliary components included in the plurality of SAV auxiliary components that enable the retrieval from the retrieval source in accordance with the assessed second commercial mission can be selected.

In various embodiments of these teachings, the control circuit(s) can be further configured to cause the selected second SAV storage area functional component(s), the selected second SAV propulsion component(s), and the selected second SAV auxiliary component(s) to be affixed onto the SAV. Each of the assessed second commercial missions can be transmitted to the SAV. The SAV can be caused to initiate the retrieval from the retrieval source according to the assessed commercial mission.

In various embodiments of these teachings, methods are provided to enable delivery of commercial products via one or more autonomous vehicles. The method can include assessing one or more commercial missions each defining one or more commercial product characteristics and delivery characteristics. The method may include selecting one or more secondary SAV storage area functional components, SAV propulsion components, and SAV auxiliary components that can enable delivery of a commercial product(s) to a delivery destination(s) in accordance with at least one of the assessed commercial missions. Each of the commercial product(s) can be characterized by one or more of the commercial product characteristics and each of the deliveries can be characterized by the delivery characteristic(s). causing, via the control circuit, At least one of the selected SAV storage area functional components, the selected SAV propulsion components, and the selected SAV auxiliary components can be caused to be affixed onto (or within) a SAV included in the (storage area) PAV.

By one approach, assessing one or more of the commercial missions can include ascertaining that at least one of the commercial product characteristic dictates a sterility condition for which one or more of the commercial products are to be maintained for the delivery, and causing the selection of one or more SAV storage area functional components included in the plurality of SAV storage area functional components that includes at least one sterility component that maintains a sterility condition of the commercial product(s) during the delivery. By one approach, assessing one or more of the commercial missions can include ascertaining that at least one of the commercial product characteristics dictate at least one climate condition for which the commercial product(s) is to be maintained for the delivery, and causing the selection of one or more SAV storage area functional components that comprises at least one climate control component.

By one approach, assessing at least one of the commercial missions includes ascertaining that one or more of the commercial product characteristics dictate maintenance of one or more of the commercial products in a gas excluding environment, and causing the selection of one or more SAV storage area functional components that comprise at least one hermetic seal component. By one approach, assessing one or more of the commercial missions can include ascertaining that one or more of the delivery characteristics dictate at least one maritime delivery destination, and causing the selection of one or more SAV propulsion components that include at least one aquatic propulsion component. In some embodiments, assessing one or more of the commercial missions includes identifying the presence along one or more of the delivery routes of at least a threshold amount of snow and/or ice, and directing the selection of at least one SAV propulsion component that includes a tracked propulsion system(s).

In various embodiments, assessing one or more of the commercial missions includes ascertaining that one or more of the delivery characteristics dictate a delivery route(s) that include a threshold number of stairs, and causing the selection of one or more SAV auxiliary components that comprises a stair climbing component. In certain embodiments, assessing one or more commercial missions includes assessing the one or more commercial missions using meteorological data for an area associated with the delivery. By one approach, the method can include transmitting code to the SAV that instructs the SAV to transmit one or more copies of the assessed commercial mission(s) to one or more second SAVs or second PAVs.

By one approach, the method may include assessing one or more second commercial missions that each include information corresponding to a retrieval characteristic(s) and a second commercial product characteristic(s) and selecting at least one SAV storage area functional component, SAV propulsion component, and SAV auxiliary component that enables retrieval of at least one commercial product from a retrieval source(s) in accordance with the one or more second commercial missions. For example, each of the commercial products can be characterized by one or more of the second commercial product characteristic and each of the retrievals can be characterized by one or more of the retrieval characteristics. In light of assessing the one or more second commercial missions, the method may include causing at least one of the selected SAV storage area functional components, SAV propulsion components, and SAV auxiliary components to be affixed onto the SAV. The method can include transmitting the assessed second commercial missions to the SAV included in the PAV. The method can include causing the SAV to initiate the retrieval of the one or more commercial products from the retrieval source(s) according to the assessed second commercial mission(s).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to enable delivery of commercial products via one or more modular autonomous vehicles, comprising:
a database comprising information corresponding to a commercial mission defining a delivery characteristic and a commercial product characteristic of a commercial product scheduled for a delivery to a delivery destination; and
a primary autonomous vehicle (PAV) comprising,
a transceiver configured to enable communication with a secondary autonomous vehicle (SAV), the SAV comprising a SAV storage area configured to temporarily receive at least one commercial product to facilitate the delivery;
a storage area configured to store the SAV, the commercial product, a plurality of SAV storage area functional components, a plurality of SAV propulsion components each configured to propel the SAV, and a plurality of SAV auxiliary components; and
a control circuit communicatively coupled to the transceiver and the database, and configured to:
assess the commercial mission;
select at least one of a SAV storage area functional component included in the plurality of SAV storage area functional components, a SAV propulsion component included in the plurality of SAV propulsion components, and a SAV auxiliary component included in the plurality of SAV auxiliary components that enables the delivery to the delivery destination in accordance with the assessed commercial mission; and
cause at least one of the selected SAV storage area functional component, the selected SAV propulsion component, and the selected SAV auxiliary component to be affixed onto the SAV.

2. The system of claim 1, wherein the control circuit in assessing the commercial mission ascertains that the commercial product characteristic dictates a sterility condition for which the commercial product is to be maintained, and causes the selection of a SAV storage area functional component included in the plurality of SAV storage area functional components that comprises a sterility component that maintains a sterility condition of the commercial product during the delivery.

3. The system of claim 1, wherein the control circuit in assessing the commercial mission selects a SAV storage area functional component of the plurality of SAV storage area functional components comprising a climate control component when the commercial product characteristic dictates a climate condition for which the commercial product is maintained for the delivery.

4. The system of claim 1, wherein the control circuit in assessing the commercial mission selects a SAV storage area functional component of the plurality of SAV storage area functional components comprising a hermetic seal component when the commercial product characteristic dictates maintenance of the commercial product in a gas excluding environment.

5. The system of claim 1, wherein the control circuit in assessing the commercial mission selects a SAV propulsion component of the plurality of SAV propulsion components comprising an aquatic propulsion component when the delivery characteristic dictates a maritime delivery destination.

6. The system of claim 1, wherein the control circuit in assessing the commercial mission identifies a presence along a delivery route of at least a threshold amount of at least one of snow and ice, and directs the selection of a SAV propulsion component comprising a tracked propulsion system.

7. The system of claim 1, wherein the control circuit in assessing the commercial mission selects a SAV auxiliary component of the plurality of SAV auxiliary components comprising a stair climbing component when the delivery characteristic dictates a delivery route comprising a threshold number of stairs.

8. The system of claim 1, wherein
the control circuit in assessing the commercial mission uses the delivery characteristic, the commercial product characteristic, and weather data for an area associated with the delivery.

9. The system of claim 1, wherein the SAV comprises:
a second transceiver; and
a second control circuit communicatively coupled to the second transceiver and configured to cause the second transceiver to transmit a copy of the assessed commercial mission to one or more of a second PAV and a second SAV, the copy of the assessed commercial mission received, via the second transceiver, from the PAV.

10. The system of claim 1, wherein
the database further comprises information corresponding to a second commercial mission defining a retrieval characteristic associated with a commercial product scheduled for a retrieval from a retrieval source and a second commercial product characteristic associated with the commercial product scheduled for retrieval, the second commercial mission comprising code that instructs the SAV to execute the retrieval from the retrieval source; and
the control circuit is further configured to:
assess the second commercial mission using at least the retrieval characteristic and the second commercial product characteristic, and select at least one of a second SAV storage area functional component of the plurality of SAV storage area functional components, a second SAV propulsion component included in the plurality of SAV propulsion components, and a second SAV auxiliary component included in the plurality of SAV auxiliary components that enables the retrieval from the retrieval source in accordance with the assessed second commercial mission;
cause the at least one of the selected second SAV storage area functional component, the selected second SAV propulsion component, and the selected second SAV auxiliary component to be affixed onto the SAV;
transmit, via the transceiver, the assessed second commercial mission to the SAV; and
cause the SAV to initiate the retrieval from the retrieval source according to the assessed commercial mission.

11. A method to enable delivery of commercial products via one or more modular autonomous vehicles, comprising:
assessing, via a control circuit included in a primary autonomous vehicle (PAV), a commercial mission defining a commercial product characteristic and a delivery characteristic, and selecting at least one of a secondary autonomous vehicle (SAV) storage area functional component, a SAV propulsion component, and a SAV auxiliary component that enables a delivery of a commercial product to a delivery destination in accordance with the assessed commercial mission, the commercial product characterized by the commercial product characteristic, the delivery characterized by the delivery characteristic; and
causing, via the control circuit, at least one of the selected SAV storage area functional component, the selected SAV propulsion component, and the selected SAV auxiliary component to be affixed onto a SAV included in the PAV.

12. The method of claim 11, wherein assessing the commercial mission comprises ascertaining, via the control circuit, that the commercial product characteristic dictates a sterility condition for which the commercial product is to be maintained for the delivery, and causing the selection of a SAV storage area functional component included in the plurality of SAV storage area functional components that comprises a sterility component that maintains a sterility condition of the commercial product during the delivery.

13. The method of claim 11, wherein assessing the commercial mission comprises ascertaining, via the control circuit, that the commercial product characteristic dictates a climate condition for which the commercial product is to be maintained for the delivery, and causing the selection of a SAV storage area functional component that comprises a climate control component.

14. The method of claim 11, wherein assessing the commercial mission comprises ascertaining, via the control circuit, that the commercial product characteristic dictates maintenance of the commercial product in a gas excluding environment, and causing the selection of a SAV storage area functional component that comprises a hermetic seal component.

15. The method of claim 11, wherein assessing the commercial mission comprises ascertaining, via the control circuit, that the delivery characteristic dictates a maritime delivery destination, and causing the selection of a SAV propulsion component that comprises an aquatic propulsion component.

16. The method of claim 11, wherein assessing the commercial mission comprises identifying, via the control circuit, a presence along a delivery route of at least a threshold amount of at least one of snow and ice, and directing the selection of a SAV propulsion component comprising a tracked propulsion system.

17. The method of claim 11, wherein assessing the commercial mission comprises ascertaining that the delivery characteristic dictates a delivery route comprising a threshold number of stairs, and causing selection of SAV auxiliary component that comprises a stair climbing component.

18. The method of claim 11, wherein
assessing the commercial mission comprises assessing, via the control circuit, the commercial mission using meteorological data for an area associated with the delivery.

19. The method of claim 11, further comprising transmitting, via the transceiver communicatively coupled to the control circuit, code to the SAV that instructs the SAV to transmit a copy of the assessed commercial mission to one or more of a second SAV and a second PAV.

20. The method of claim 11, further comprising:
assessing, via the control circuit, a second commercial mission comprising information corresponding to a retrieval characteristic and a second commercial product characteristic and selecting at least one of the SAV storage area functional component, the SAV propulsion component, and the SAV auxiliary component that enables retrieval of a commercial product from a retrieval source in accordance with the second commercial mission, the commercial product characterized by the second commercial product characteristic, the retrieval characterized by the retrieval characteristic;
causing, via the control circuit, at least one of the selected SAV storage area functional component, the selected SAV propulsion component, and the selected SAV auxiliary component to be affixed onto the SAV;
transmitting, via the transceiver communicatively coupled to the control circuit, the assessed second commercial mission to the SAV included in the PAV; and
causing, via the control circuit, the SAV to initiate the retrieval of the commercial product from the retrieval source according to the assessed second commercial mission.
